(19) United States
(12) Patent Application Publication
(10) Pub. No.: US 2026/0215621 A1
(43) Pub. Date: Jul. 30, 2026

(54) SMOKING/GRILLING ARTICLE AND METHOD

(71) Applicants: Robert Luther, Chester, CT (US); Michael Luther, Chester, CT (US)

(72) Inventors: Robert Luther, Chester, CT (US); Michael Luther, Chester, CT (US)

(21) Appl. No.: 19/040,269

(22) Filed: Jan. 29, 2025

(51) Int. Cl. A47J 37/07; A23B 4/052; A47J 36/32; F24C 7/08; H05B 1/02

(52) U.S. Cl. CPC A47J 37/0718; A23B 4/0523; A47J 36/32; A47J 37/0754; A47J 37/0759; A47J 37/0786; F24C 7/08; H05B 1/0261

(57) ABSTRACT

A smoking/grilling article includes a controller, an article body defining a body top opening communicated with a body cavity, wherein the body cavity includes a food section, a grilling section and a smoking section, a food grate disposed in the food section proximate the body top opening, a grilling grate disposed below the food grate in the grilling section and a smoking grate disposed below the grilling grate in the smoking section, wherein each of the grilling grate and the smoking grate include one or more hollow grate tubes containing one or more heating elements therein, and wherein the controller is electrically communicated with the one or more heating elements to control the operation of the one or more heating elements.

### FIELD OF THE INVENTION

The present invention relates to a meat smoking/grilling article, and more particularly to a meat smoking/grilling article and a method for operating the meat smoking/grilling article.

### BACKGROUND OF THE INVENTION

Smoking meat and other food articles is well known and has been practiced for several hundred years. One of the main reasons that people began to smoke meat was due to the preservation qualities imparted by the smoking process. The smoking process causes the meat to emit an acid which creates a skin that covers the outside of the meat and that acts to prevent growth of surface mold or bacteria within the meat. As refrigeration has only been commonly available for the last 100 years or so, smoking meat was a necessary preservation practice because the meat would spoil relatively quickly and smoking the meat allowed for an extended period of time in which the meat would be consumable. However, with the invention of refrigeration, smoking meat to preserve the meat was no longer necessary. Accordingly, due to the flavor imparted to the meat via the smoking process, the smoking of meat became more of a hobby and business.

Smoking meat, such as a pork shoulder or beef briskets, requires exposing the meat to smoke and low cooking temperatures (180-250 degrees° F.) under controlled conditions for a long period of time (approximately 8-16 hours). This exposure causes the meat to be more tender, without drying the meat out, due to the tendons in the meat being broken down during the smoking and cooking process. Cooking the meat in these controlled conditions over a coal or wood fire creates the delicious phenomenon known as bar-b-que (i.e. fork tender chunks of meat enhanced with mouth-watering smoke flavor). Businesses or individuals that smoke large amounts of meat, typically employ a smokehouse, which is an enclosed building having no windows and a vent. In this case, the meat is located within the smokehouse enclosure, which is then filled with smoke so that the smoke contacts the meat. However, individuals that smoke meat as a hobby typically don't need the capacity of a smokehouse or have the money to build a smokehouse.

Accordingly, there are a variety of meat smoking devices currently available that are sized to the hobbyist. Typically, these devices are portable devices that are similar in design (and in some cases may be integrated with) an ordinary gas barbecue grill. These devices have an area under the grill or a separate ‘firebox’ onto the side of the grill, which holds the meat, and which is designed to hold a smoking source, such as wood chips or smoking coals. Once the smoking source is ignited, the cover is closed and the smoke from the burning or smoldering smoking source flows into the grilling area and contacts the meat. As with the smokehouse, the fire must be tended for the duration of the process which can be as long as 16 hours. Only a small percentage of the cooking population can devote this amount of time to preparing smoked meat.

### SUMMARY OF THE INVENTION

A smoking/grilling article is provided and includes a controller, an article body defining a body top opening communicated with a body cavity, wherein the body cavity includes a food section, a grilling section and a smoking section, a food grate disposed in the food section proximate the body top opening, a grilling grate disposed below the food grate in the grilling section and a smoking grate disposed below the grilling grate in the smoking section, wherein each of the grilling grate and the smoking grate include one or more hollow grate tubes containing one or more heating elements therein, and wherein the controller is electrically communicated with the one or more heating elements to control the operation of the one or more heating elements.

A smoking/grilling article is provided and includes a controller, an article body defining a body top opening and a body bottom opening and having an article bottom, wherein the body top opening and the body bottom opening are communicated with a body cavity, wherein the body cavity includes a food section, a grilling section and a smoking section, a food grate disposed in the food section proximate the body top opening, a grilling grate disposed below the food grate in the grilling section, a smoking grate disposed below the grilling grate in the smoking section, wherein each of the grilling grate and the smoking grate include one or more hollow grate tubes containing one or more heating elements therein, and wherein the controller is electrically communicated with the one or more heating elements to control the operation of the one or more heating elements, and wherein the article bottom is removably associated with the article body to cover/uncover the body bottom opening.

### BRIEF DESCRIPTION OF THE DRAWINGS

The foregoing and other features and advantages of the present invention will be better understood from the following detailed description of illustrative embodiments, taken in conjunction with the accompanying drawings in which:

FIG. 1 is a front view of a smoking/grilling article, according to an embodiment.

FIG. 2 is a rear view of the smoking/grilling article of FIG. 1, according to an embodiment.

FIG. 3A is a side view of the smoking/grilling article of FIG. 1 showing the top portion of the smoking/grilling article in a closed configuration, according to an embodiment.

FIG. 3B is a side view of the smoking/grilling article of FIG. 1 showing the top portion of the smoking/grilling article in an open configuration, according to an embodiment.

FIG. 4 is a front view of the smoking/grilling article of FIG. 1, according to an embodiment.

FIG. 5A is a side view of the smoking/grilling article of FIG. 1 showing the top portion, the grilling section door and the smoking section door of the smoking/grilling article in an open configuration, according to an embodiment.

FIG. 5B is a perspective view of the smoking/grilling article of FIG. 1 showing the top portion, the grilling section door and the smoking section door of the smoking/grilling article in a closed configuration, according to an embodiment.

FIG. 6A is a front view of the smoking/grilling article of FIG. 1, according to an embodiment.

FIG. 6B is a side view of the smoking/grilling article of FIG. 1, according to an embodiment.

FIG. 7 is a plan view of a heating grate having an integrated heating element for use with the smoking/grilling article of FIG. 1, according to an embodiment.

FIG. 8 is a top-down view of Section A-A of the smoking/grilling article of FIG. 1 showing the first heating grate disposed within the body chamber of the smoking/grilling article, according to an embodiment.

FIG. 9 is a sectional side view of the heating grate of FIG. 7 from points B-B, according to an embodiment.

FIG. 10 is a perspective view of a smoking/grilling article, according to an embodiment.

FIG. 11 shows a plurality of different locking structures for the article bottom of a smoking/grilling article, according to an embodiment.

FIG. 12 shows a side view of the article bottom of a smoking/grilling article being removed and attached to the article body, according to an embodiment.

FIG. 13 shows a plurality of different locking structures for the grilling (or cooking) section door and the smoking section door, according to embodiments.

FIG. 14 shows a grate with a heating element mounted onto a support device within the article body, according to an embodiment.

FIG. 15A shows the grate of FIG. 14 with the heating element being mounted onto a support device within the article body, according to an embodiment.

FIG. 15B shows the grate of FIG. 14 with the heating element being mounted onto a support device within the article body, according to an embodiment.

FIG. 15C shows the grate of FIG. 14 with the heating element being mounted onto a support device within the article body, according to an embodiment.

FIG. 16 shows a grate with the heating element mounted onto a support device within the article body, according to another embodiment.

FIG. 17 shows a grate having a plurality of heating elements, according to an embodiment.

FIG. 18 shows a cross-sectional view of the grate of FIG. 17 having a plurality of heating elements, according to an embodiment.

FIG. 19 shows a grate with a heating element connected to electrical connections via a plug-in connector, according to an embodiment.

FIG. 20A shows the heating element of FIG. 19 being plugged into power connections located within the article body, according to an embodiment.

FIG. 20B shows the heating element of FIG. 19 being plugged into power connections located within the article body, according to an embodiment.

### DETAILED DESCRIPTION

In accordance with an embodiment, a smoking/grilling article that allows for char-grilling of steaks and fish as well as for smoking of tougher cuts of meat, such as beef brisket and pulled pork, is provided. As char-grilling requires radiant heat from a charcoal fire that is in relatively close proximity to the food being grilled, the smoking/grilling article has a dedicated grilling grate (for holding grilling fuel, such as charcoal, wood, etc.) disposed in an optimal location for grilling. The grilling grate includes at least one heating element embedded with or contained within the grilling grate to ignite fuel for grilling food and/or increasing maintaining temperature within the smoking/grilling article. Moreover, the smoking/grilling article also includes a dedicated smoking grate (for holding smoking fuel, such as wood chips, etc.) disposed lower within the smoking/grilling article for producing smoke for smoking meats, where charcoal, wood chips, wood chunks or any other combination of smoking fuel can be used. The smoking grate also includes at least one heating element embedded with or contained within the smoking grate to ignite fuel for producing smoke used to smoke food. Additionally, the smoking/grilling article is insulated and vented to allow for precise temperature control and smoke flow.

In an embodiment, the smoking/grilling article also includes a grilling grate access door and a smoking grate access door to allow a user to add/replenish/remove fuel or to manually restart the fire if needed. Moreover, the smoking/grilling article of the invention features a patented infrared heating and control system to augment the fuel fires. The smoking/grilling article may include a plurality of operational modes, including a ‘manual mode’ and an ‘auto mode’. When in the ‘manual mode’, the smoking/grilling article may be operated and controlled as desired by a user. When in the ‘auto mode’, the smoking/grilling article may be automatically operated based on programmable features, such as maintaining a desired temperature within the smoking/grilling article. For example, the heating elements may be automatically energized/deenergized to re-ignite fuel (i.e., charcoal, wood, etc.) contained therein and/or to introduce additional heat to maintain a desired temperature within. Furthermore, the smoking/grilling article may be used as an oven/food warmer heated solely by the heating elements within the fuel grates thereby requiring no fuel at all.

Accordingly, when fuel is disposed on the fuel grates and the heating elements are energized, the heating elements are configured to heat the fuel grates to a high enough temperature such that the fuel disposed on the fuel grate ignites, and a fire is started/maintained. Moreover, the grilling heating element may be programmable to maintain a constant temperature within the unit for a predetermined period of time, while keeping the grilling heating element distant from the heat of the fire generated by the burning smoking fuel.

In an embodiment, each of the heating elements may be programmed to operate within a desired wattage and/or to not exceed a desired wattage as desired based on the power characteristics of the power source being used. For example, in an embodiment, if the smoking/grilling article is being powered by a typical household, then the smoking/grilling article may be programed to not exceed a power draw of about 1750 watts. It should be appreciated that the heating elements, when used in conjunction with the doors, help to ensure that the fire can be maintained without disturbing the food and with a minimum of heat loss from the enclosure of the smoking/grilling article. Accordingly, a unique aspect of the invention is that the fuel grates allow the grilling and/or smoking fires to be started as well as the temperature within the enclosure to be maintained. Another unique aspect includes the ability to program and separately control the heating element within the grilling grate and the heating element within the smoking grate to work in concert with each other to start the grill and maintain the temperature within the smoking/grilling article enclosure without exceeding the power wattage of the power source outlet, even if they may exceed the power wattage limitation of the power source outlet if operated individually.

In an embodiment, the smoking/grilling article includes a grilling access door and a smoking access door, where the grilling access door allows a user to access the grilling grate, add fuel or to restart the grilling fire if needed and the smoking access door allows a user to access the smoking grate, add fuel or to restart the smoking fire if needed.

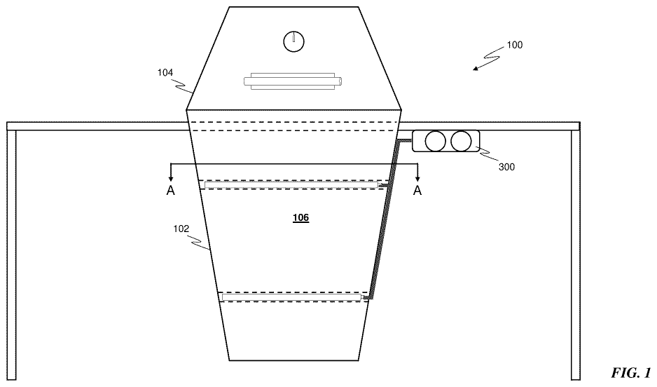

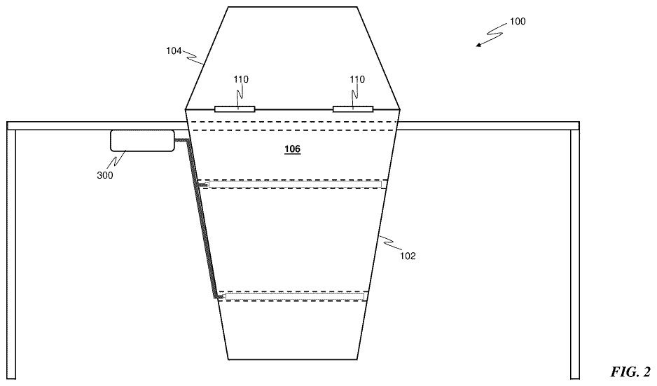

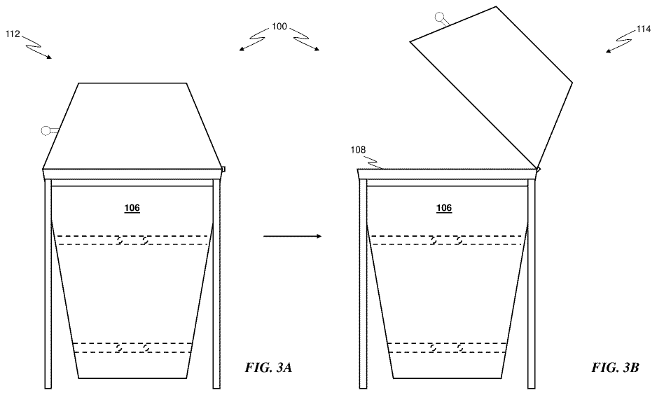

In accordance with an embodiment and referring to FIG. 1, FIG. 2, FIG. 3A and FIG. 3B, a smoking/grilling article 100 is shown and includes an article body 102 and an article top 104, where the article body 102 defines a body chamber 106 and a body top opening 108 which is communicated with the body chamber 106. The article top 104 is movably associated with the article body 102 to allow the article top 104 to cover and uncover the body top opening 108. In an embodiment, the article top 104 is connected to the article body 102 via one or more hinge devices 110 which allow the article top 104 to be rotated between a covered configuration 112 (FIG. 3A) and an uncovered configuration 114 (FIG. 3B). In another embodiment, the article 104 may be removable. It should be appreciated that when the article top 104 is in the covered configuration 112, the body top opening 108 is covered and the body chamber 106 is not accessible, and when the article top 104 is in the uncovered configuration 114, the body top opening 108 is uncovered and the body chamber 106 is accessible via the body top opening 108.

It should be appreciated that in an embodiment, the article body 102 and/or the article top 104 may be constructed from any material suitable to the desired end purpose, such as a ceramic material and/or a metal material, such as aluminum, stainless steel and/or a cold rolled steel which may be treated with a powder coating and/or an enamel material. Moreover, in another embodiment, the article body 102 and/or the article top 104 may be constructed to be insulated to enhance its ability to retain heat and/or maintain temperature within the body chamber 106. Thus, in an embodiment, the article body 102 and/or the article top 104 may be treated with an insulative material and/or the article body 102 and/or the article top 104 may be constructed from a layered material having an inner layer separated from an outer layer by an insulation material contained therebetween.

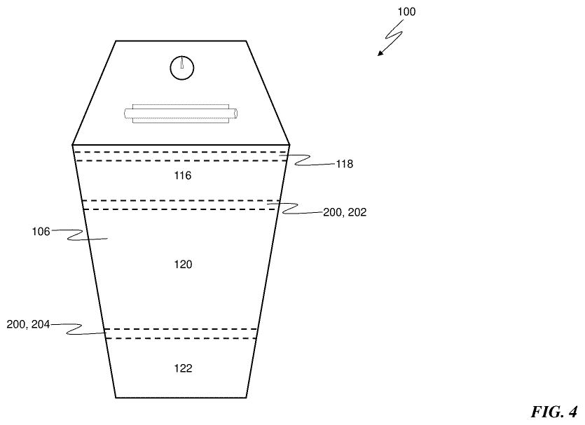

In an embodiment and referring to FIG. 4, the body chamber 106 is divided into three (3) sections, where each of the three (3) sections are separated by a heating grate 200. The first section 116 is a cooking section which is located within a top portion of the body chamber 106 and which includes a first heating grate 202 that is used to hold cooking fuel. When the first heating grate 202 is operated, heating elements within the first heating grate 202 causes the cooking fuel to ignite and burn thereby generating heat for cooking any food which may be located on a food grate 118 that is disposed above the first heating grate 202 within the cooking section 116. The second section 120 is a smoking section which is located within a central portion of the body chamber 106 and which includes a second heating grate 204 that is used to hold smoking fuel. When the second heating grate 204 is operated, heating elements within the second heating grate 204 causes the smoking fuel to ignite and burn, thereby generating smoke and heat which fills the body chamber 106. The smoke and heat generated by the smoking fuel rises within the body chamber 106 to flow through the smoking section 120 and the cooking section 116. Thus, the smoke will encounter and bath any food that is located on the food grate 118 that is located within the cooking section 116.

The third section 122 is a waste section which is located in a bottom portion of the body chamber 106 to be below the second heating grate 204. The waste section 122 is configured to ‘catch’ any of the spent cooking and smoking fuel which is depleted during the burning process. As the cooking and smoking fuel burns, the ashes and smaller unburned fuel particles will fall through openings in the first heating grate 202 and the second heating grate 204 thereby landing in the waste section 122. The waste section 122 can then be easily cleaned by removing the ashes and smaller unburned fuel particles from the waste section 122.

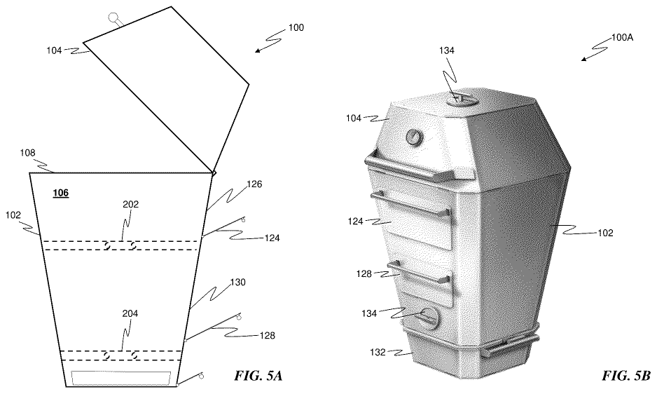

In an embodiment and referring to FIG. 5A, the article body 102 includes a grilling section door 124 which is configurable to cover and uncover a cooking section opening 126, wherein the cooking section opening 126 is located and sized to allow a user to insert and disposed cooking fuel on the first heating grate 202. Additionally, the article body 102 further includes a smoking section door 128 which is configurable to cover and uncover a smoking section opening 130, wherein the smoking section opening 130 is located and sized to allow a user to insert and disposed smoking fuel on the second heating grate 204. FIG. 5B shows another embodiment of a smoking/grilling article 100A where the article body 102 includes a removable bottom portion 132. Accordingly, since the bottom portion 132 (or waste section 122) is removable, a user simply disconnects the bottom portion 132 (i.e. the waste section 122) from the article body 102, cleans the waste from within the bottom portion 132 and reconnects the bottom portion 132 to the article body 102. Additionally, the article body 102 may further include one or more vent openings 134 located in a bottom area and/or top area of the article body 102, where the one or more vent openings 134 may be adjustable in size to regulate airflow through the body chamber 106. It is contemplated that the smoking/grilling article 100 may include one or more temperature sensors disposed throughout the article body 102 to sense temperature(s) and temperature gradients within the body chamber 106. Additionally, the smoking/grilling article 100 may include one or more fans disposed throughout the article body 102 to control airflow within the body chamber 106 by increasing and/or directing within the body chamber 106.

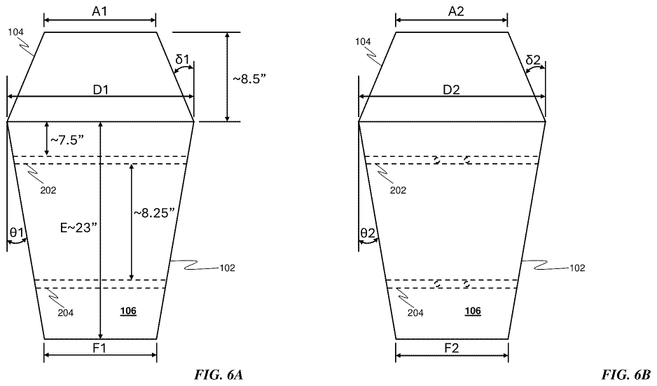

In an embodiment and referring to FIG. 6A and FIG. 6B, the article body 102 is essentially shaped as an inverted (upside-down) trapezoid where the top portion is wider than the bottom portion and where the widest width D1 from the front is larger than the widest width D2 from the side. Referring to FIG. 6A which shows a front view of the article body 102, the top portion of the article body 102 includes a width D1 of about 21 inches and the bottom portion of the article body 102 includes a width F1 of about 12.25 inches. The sides of the article body 102 extend from the top portion to the bottom portion at an angle θ1 of about 11 degrees. The article top 104 is essentially shaped as a trapezoid where the bottom portion of the article top 104 is wider than the top portion of the article top 104 and where the widest width D1 from the front is larger than the widest width D2 from the side. The bottom portion of the article top 104 includes a width D1 of about 21 inches and the top portion of the article top 104 includes a width A1 of about 14 inches. The sides of the article top 104 extend from the top portion to the bottom portion at an angle δ1 of about 22 degrees.

Referring to FIG. 6B which shows a side view of the article body 102, the top portion of the article body 102 includes a width D2 of about 17.25 inches and the bottom portion of the article body 102 includes a width F2 of about 9.5 inches. The sides of the article body 102 extend from the top portion to the bottom portion at an angle θ2 of about 9.5 degrees. The bottom portion of the article top 104 includes a width D2 of about 17.25 inches and the top portion of the article top 104 includes a width A2 of about 14.5 inches. The sides of the article top 104 extend from the top portion to the bottom portion at an angle θ2 of about 9 degrees. Additionally, the article body 102 has a height E of about 23 inches and the article top 104 has a height B of about 8.5 inches. It should be appreciated that the first heating grate 202 is disposed within the body chamber 106 to be located at a point that is about 7.5 inches away from the top portion of the article body (i.e., first heating grate 202 to flat) and that the second heating grate 204 is disposed within the body chamber 106 to be located at a point that is about 8.25 inches from the first heating grate 202. Accordingly, the first heating grate 202 is separated from the second heating grate 204 by about 8.25 inches. It should be appreciated that all of the dimensions (distances and angles) disclosed herein may be adjusted by about ±20%.

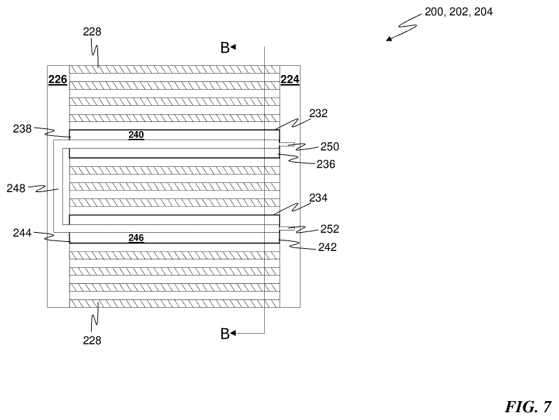

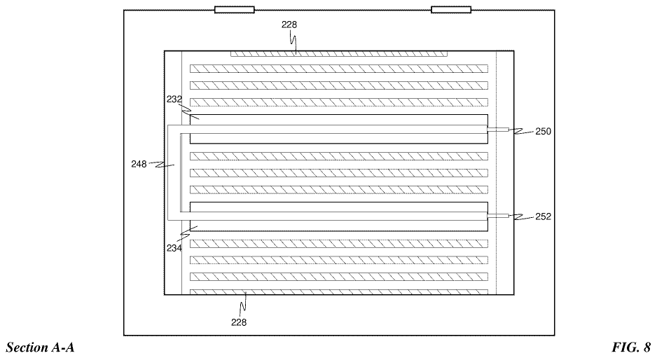

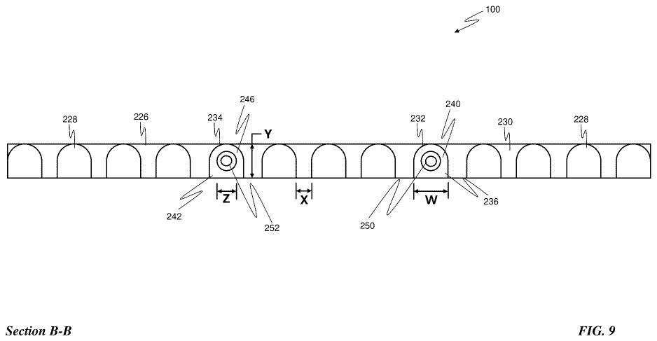

In an embodiment and referring to FIG. 7, FIG. 8 and FIG. 9, as discussed briefly above, the smoking/grilling article 100 includes a heating grate 200 which is removably contained and supported within the cooking section 116 and the smoking section 120. The heating grate 200 includes a first side panel 224 and a second side panel 226 separated by a plurality of grate support rods 228, wherein the plurality of grate support rods 228 extend between the first side panel 224 and the second side panel 226 and are disposed adjacent to each other such that a space X exists between each of the grate support rods 228. Each of the first side panel 224 and the second side panel 226 define a side panel cavity 230, where one end of each of the plurality of grate support rods 228 are securely disposed within the side panel cavity 230 of the first side panel 224 and the other end of each of the plurality of grate support rods 228 are securely connected to or disposed within the side panel cavity 230 of the second side panel 226.

The heating grate 200 further includes a first heating element tube 232 and a second heating element tube 234, wherein the first heating element tube 232 includes a first tube first end opening 236 communicated with a first tube second end opening 238 via a first tube cavity 240 and wherein the second heating element tube 234 includes a second tube first end opening 242 communicated with a second tube second end opening 244 via a second tube cavity 246. The first heating element tube 232 is associated with the heating grate 200 to be located proximate a central portion of the heating grate 200 such that the first tube first end opening 236 is located within the side panel cavity 230 of the first side panel 224 and the first tube second end opening 238 is located within the side panel cavity 230 of the second side panel 226. The second heating element tube 234 is associated with the heating grate 222 to be located proximate a central portion of the heating grate 222 such that the second tube first end opening 242 is located within the side panel cavity 230 of the first side panel 224 and the second tube second end opening 244 is located within the side panel cavity 230 of the second side panel 226.

The heating grate 200 further includes an electrically powered heating element 248 which includes a heating element first end 250 and a heating element second end 252. The heating element 248 is contained withing the first heating element tube 232 and the second heating element tube 234 such that the heating element first end 250 is protruding out of the first tube first end opening 236 to be disposed within the side panel cavity 130 of the first side panel 224 and such that the heating element second end 252 is protruding out of the second tube first end opening 242 to be disposed within the side panel cavity 230 of the first side panel 224. Additionally, a portion of the heating element 248 protrudes from both the first tube second end opening 238 and the second tube second end opening 244 such that a “U” shaped portion of the heating element 248 is contained within the side panel cavity 230 of the second side panel 226. It should be appreciated that the first heating element tube 232 and the second heating element tube 234 are partially arcuate in shape (in other embodiments, they may be other shapes, such as circular, rectangular, octagonal, etc.) and include a height Y of about ⅜ inches and a width W (at its widest point) of about ⅝ inches. Moreover, the heating element 248 which is contained within the first tube cavity 240 and the second tube cavity 246 includes a heating element diameter Z of approximately ⅜ inches. The heating element first end 250 and the heating element second end 252 are configured to connect with a processing device 254 to allow the processing device 254 to control the power being applied to the heating element 248 and thus to control the heat generated by the heating element 248.

In an embodiment and referring again to FIG. 1 and FIG. 2, the smoking/grilling article 100 includes a controller 300 having a processing device, wherein the controller 300 is electrically connected to the first heating grate 202 and the second heating grate 204 to control the power being delivered to the heating elements 248 of the first heating grate 202 and the second heating grate 204. In an embodiment, the controller 300 and the heating elements 248 are programmable to limit (and/or balance between the heating elements 248) the amount of power being delivered to the heating elements 248 to about 1750 Watts to achieve and maintain a cooking temperature at the food grate 118 of about 350 degrees Fahrenheit. Accordingly, the one or more temperature sensors will sense the temperature at one or more locations within the body chamber 106, such as the temperature at the food grate 118. This temperature is then communicated with the controller 300 which may adjust the power input to the heating elements 248 and/or control the airflow by controlling the fan airflow and direction.

It should be appreciated that, in an embodiment, the controller 300 may include two controllers or may allow for one controller to control both the grilling grate 202 and the smoking grate 204. The controller 300 that controls the grilling grate 202 may provide the following capabilities: Full on/off timer (for example 30 minute) for starting fuel disposed on the grilling grate 202; automatic temperature control (which may be based on one or more of the temperature sensors disposed within) the body chamber 106. Additionally, the controller 300 that controls the smoking grate 204 may provide the following capabilities: Full on/off timer (for example 30 minute) for starting fuel disposed on the smoking grate 204. It should be further appreciated that the controller(s) 300 may be electrically connected to the grilling grate 202 and the smoking grate 204 via any device and/or method suitable to the desired end purpose, such as a hardwire connection which may include a quick disconnect device, a ring terminal device and or a junction box device. Additionally, the smoking/grilling article 100 may be powered via a battery and/or an electrical power wire configured to electrically connect to a power source, such as an electrical service to a building and/or a generator.

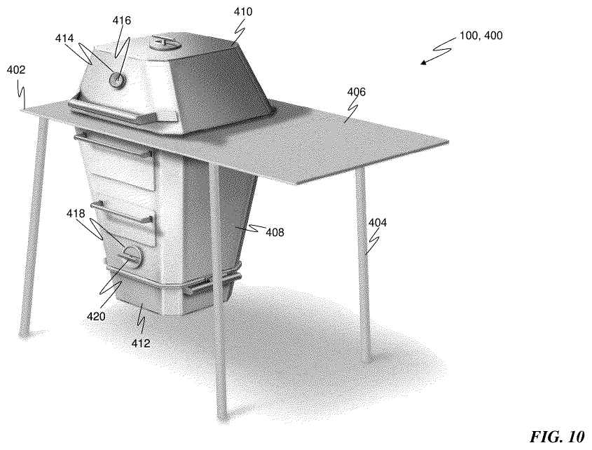

In an embodiment and referring to FIG. 10, a smoking/grilling article 400 is shown and includes a support structure 402 having a plurality of support legs 404 and a support platform 406. The smoking/grilling article 400 includes an article body 408 defining a body chamber 106 for containing the food grate 118, the grilling grate 202 and the smoking grate 204, an article top 410 for enclosing the top opening of the body chamber 106 and an article bottom 412 for enclosing the bottom opening of the body chamber 106. The smoking/grilling article 400 is supported by the support structure 402 such that the smoking/grilling article 400 is positioned above the ground, floor or support platform. The article top 410 is rotatably configurable between an open configuration and a closed configuration to cover/uncover the top opening of the article body 408.

The smoking/grilling article 400 includes a first vent opening 414 defined in the article top 410 which may be covered/uncovered via a vent actuator 416 to allow the vent opening 414 to be partially or wholly covered/uncovered. The smoking/grilling article 400 further includes a second vent opening 418 defined in the article body 408 to be located proximate a bottom portion of the article body 408 which may be covered/uncovered via a vent actuator 420 to allow the vent opening 418 to be partially or wholly covered/uncovered. The smoking/grilling article 400 includes a grilling (or cooking) section door 124 and a smoking section door 128, wherein the grilling section door 124 is configurable between an open configuration and a closed configuration to allow access to the grilling grate 202 and wherein the smoking section door 128 is configurable between an open configuration and a closed configuration to allow access to the smoking grate 204.

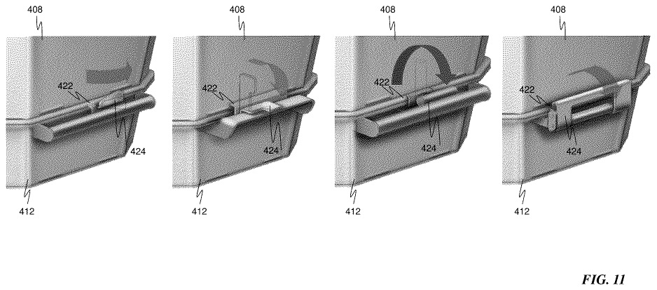

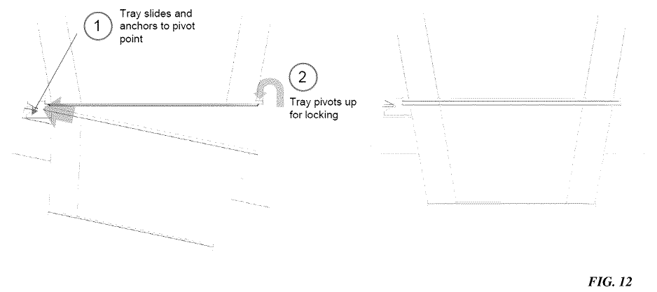

In an embodiment, the article bottom 412 is removably associated with the article body 408 to cover/uncover a body bottom opening. This allows spent fuel (ashes, wood chips, charcoal chips, etc. to be easily removed from the body chamber 106. The article bottom 412 may be removably connected to the article body 408 via any device and/or method suitable to the desired end purpose, such via the use of configurable catches and latches as shown in FIG. 11 and FIG. 12. The article body 408 includes a plurality of body engaging structures 422 and the article bottom 412 includes a plurality of bottom engaging structures 424, wherein the plurality of body engaging structures 422 the plurality of bottom engaging structures 424 interact with each other to removably and securely connect the article bottom 412 to the article body 408. Accordingly, as the spent fuel builds up within the article bottom 412, the article bottom 412 can be removed from the article body 408, the spent fuel disposed of and the article bottom 412 can be reconnected to the article body 408.

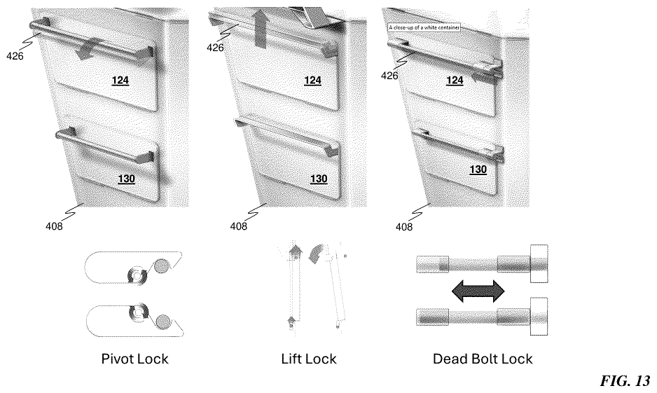

In an embodiment and referring to FIG. 13, the grilling section door 124 and the smoking section door 128 are rotatably associated with the article body 408 to cover/uncover the grilling section opening 126 and the smoking section opening 130. It should be appreciated that the grilling section door 124 and the smoking section door 128 may be rotatably associated with the article body 408 via any device and/or method suitable to the desired end purpose, such via the use of a configurable pivot lock, lift lock and/or dead-bolt lock, as shown in FIG. 13. The article body 408 includes a plurality of body engaging structures 426 which lockingly engage with door locking structures on the grilling section door 124 and the smoking section door 128. In yet another embodiment, the grilling section door 124 and the smoking section door 128 may be rotatably and resiliently associated with the article body 408 via a spring device such that when one or both of the grilling section door 124 and/or the smoking section door 128 are configured from a closed configuration (i.e., covering the grilling section opening 126 and/or the smoking section opening 130) into an open configuration (i.e., uncovering the grilling section opening 126 and/or the smoking section opening 130), the spring device will experience a tension such that the one or both of the grilling section door 124 and/or the smoking section door 128 will be reconfigured back into the closed configuration.

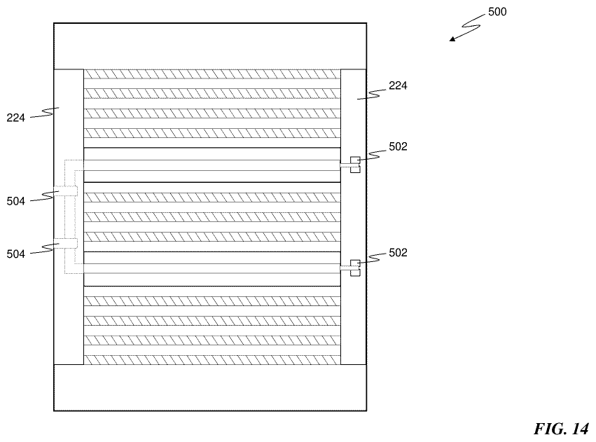

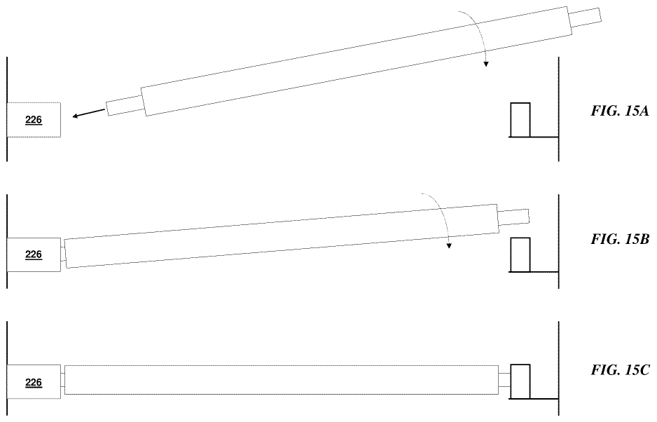

Referring to FIG. 14, a grate 500 (such as the grilling grate 202 and/or the smoking grate 204) having a heating element 248 mounted within the body chamber 106 of the article body 102 is shown, wherein a first end of the heating element 248 is supported within the second side panel 226 via any supporting and securing device suitable to the desired end purpose. A second end of the heating element 248 includes the electrical connections 250, 252 which connects to the power source (i.e., a battery, a generator or a public/private power source). The electrical connections 250, 252 are mounted to a first side panel 224 which acts as a support plate for the electrical connections 250, 252. Each of the electrical connections are securely held mounted to the first side panel 224 by being compressed with metal retaining clips 502. This acts to ensure that the electrical connections 250, 252 are electrically and conductively connected with the retaining clips 502 which are in turn electrically and conductively connected to a power source. Referring to FIGS. 15A, 15B and 15C, the grate 500 is securely associated with the article body 102 by inserting the first end of the heating element 246 within the second side panel 226 such that the first end of the heating element 248 is compressingly associated with a mounting device 504. The grate is then rotated toward the metal retaining clips 502 located on the first side panel 224 and the electrical connections 250, 252 are pressed into the cavity of the retaining clips 502.

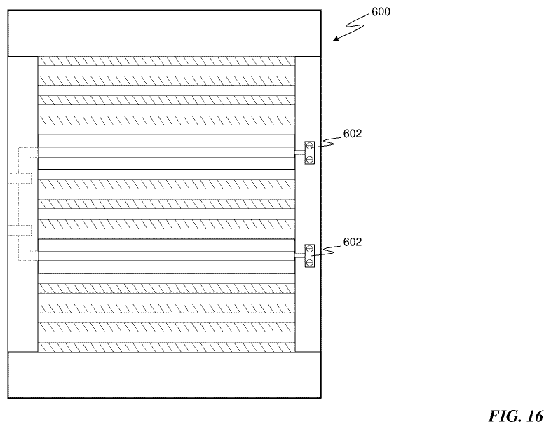

Referring to FIG. 16, a grate 600 (such as the grilling grate 202 and/or the smoking grate 204) having a heating element 248 mounted within the body chamber 106 of the article body 102 is shown, wherein a first end of the heating element 248 is supported within the second side panel 226 via any supporting and securing device suitable to the desired end purpose. As with the grate 500 in FIG. 14, the second end of the heating element 248 includes the electrical connections 250, 252 which connects to the power source (i.e., a battery, a generator or a public/private power source). The electrical connections 250, 252 are mounted to a first side panel 224 which acts as a support plate for the electrical connections 250, 252. Each of the electrical connections are securely held mounted to the first side panel 224 by a terminal mount 602. As above, this acts to ensure that the electrical connections 250, 252 are electrically and conductively connected with the retaining clips 502 which are in turn electrically and conductively connected to a power source.

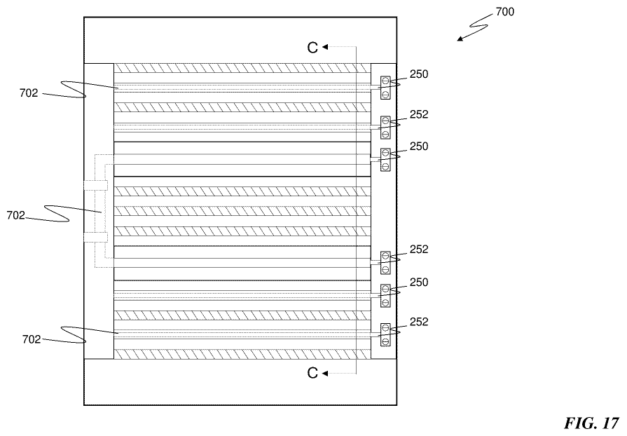

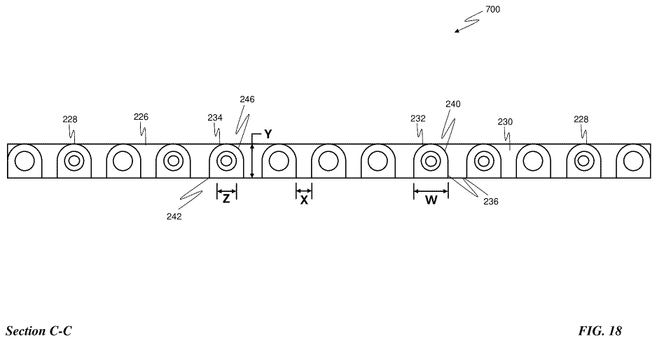

Referring to FIG. 17 and FIG. 18, a grate 700 (such as the grilling grate 202 and/or the smoking grate 204) having a plurality of heating elements 702 mounted within the body chamber 106 of the article body 102 is shown, wherein a first end of each of the heating element 702 is supported within the second side panel 226 via any supporting and securing device suitable to the desired end purpose. As with the grate 500 in FIG. 14, the second end of the heating element 702 includes the electrical connections 250, 252 which connects to the power source (i.e., a battery, a generator or a public/private power source). The electrical connections 250, 252 are mounted to a first side panel 224 which acts as a support plate for the electrical connections 250, 252. Each of the electrical connections are securely held mounted to the first side panel 224 by any device and or method suitable to the desired end purpose, such as a terminal mount 602 and/or a retaining clip 502. As above, this acts to ensure that the electrical connections 250, 252 are electrically and conductively connected with the retaining clips 502 which are in turn electrically and conductively connected to a power source.

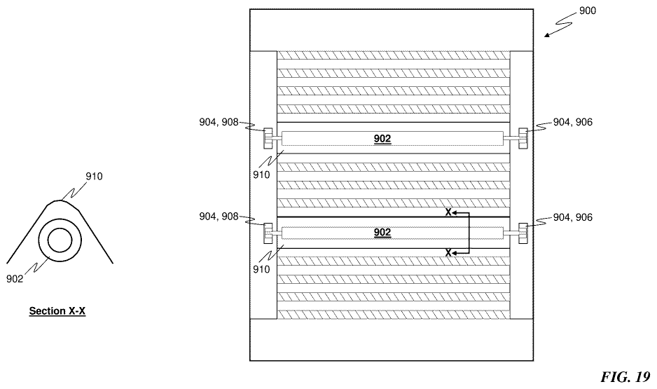

It should be appreciated that although heating elements 248, 702 are described hereinabove with regards to heating elements 248, 702 having a “U” shaped portion, in other embodiments, the smoking/grilling article 100 may include other types of heating elements. In an embodiment and referring to FIG. 19, one or more plug-in heating elements 900 may be used within a grate 900, the “plug-in” heating element 902 may plug into electrical connections 904 disposed on opposing internal sides of the article body 102. The electrical connections 904 may include a first electrical connection 906 and a second electrical connection 908, wherein the first electrical connection 906 is configured to springingly receive and contain one end of heating element 902 and the second electrical connection 908 is configured to springingly receive and contain the other end of heating element 902. This advantageously allows for a quick and easy removal and/or replacement of the one or more heating element(s) 902 as well as the ability to clean the grate 900 without damaging the heating element(s) 902.

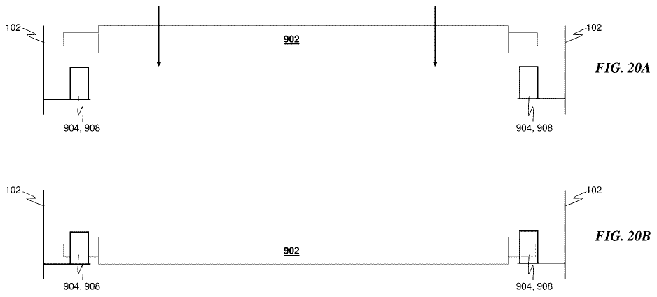

Referring to FIGS. 20A and 20B, the “plug-in” heating element 902 is shown being ‘plugged into’ the first electrical connection 906 and the second electrical connection 908. It should be appreciated that the first electrical connection 906 and a second electrical connection 908 are connected to a power supply (i.e., external power source, battery, etc.) to supply power to the “plug-in” heating element 902 via the first electrical connection 906 and the second electrical connection 908. Moreover, the grate 900 may include one or more open-bottom heating element ‘tubes’ 910 which allow the heating element 902 to be plug-in connected to the first electrical connection 906 and the second electrical connection 908, where the grate 900 is then located above the heating elements 902 to contain the heating element 902 within the open bottomed tube 910. Additionally, the first electrical connection 906 and the second electrical connection 908 may be connected to a controller/processor to control the power to the heating element 902 via the first electrical connection 906 and a second electrical connection 908.

Moreover, it should be appreciated that in other embodiments, the heating elements may be connected to the power source via any method and/or device suitable to the desired end purpose, such as male-male connections, female-female connections and female-male connections. Additionally, the grilling grate and/or the smoking grate may be constructed from a material which conducts heat, such as aluminum, stainless steel and/or a cold rolled steel which may be treated with a powder coating and/or an enamel material.

It should be appreciated that the smoking/grilling article 100 may include an Infrared Heating and Control System (IHCS) which include sensors within the article body 102 for sensing and interacting with the processing device to control how the Nichrome heating elements embedded within the grilling and smoking grates are controlled to start fires and to maintain desired temperature with the article body 102. Additionally, although the total wattage of the heating elements will be more 1750 watts (i.e., the typical maximum wattage for a household receptacle), the IHCS and/or the processor may prevent the heating elements (either on the same grate or heating elements on different grates) from being powered at the same time. Additionally, the IHCS and/or the processor may multiplex the operation of multiple heating elements (either on the same grate or heating elements on different grates) to allow for robust smoking and/or grilling functions while not allowing the smoking/grilling article 100 to draw more than about 1750 watts (or some other preset wattage amount).

Additionally, the smoking/grilling article 100 may be programmable to allow different operational modes, such as “start smoking fire mode”, “maintain temperature mode”, “start grilling fire mode”, etc. In these modes one or more of the heating elements may be power on for a predetermined amount of time (such as, for example 20 minutes) and then powered off. Another option may include “auto-temp” where the user sets the desired temperature within the article body 102 and the IHCS and/or the processor turns one or more (selected as desired) of the heating elements on and off to maintain the temperature within the cooking chamber as measured by a temperature sensor. It should be associated that if the grates include multiple heating elements, individual heating elements may be powered on and/or off based on a temperature within chamber ‘zone’ proximate the heating element.

Furthermore, the shape of the article body 102 and the article top 104 is configured to minimize the volume required to be heated, while providing a sufficient grilling space. Additionally, the shape works to funnel air toward smoking fuel located on the smoking grate 204 to allow the smoking fuel to ignite more slowly than large chambers and to produce a greater and cleaner volume of smoke which will rise upward and bath any food (meat/fish/vegetables) located on the cooking grate 118. As a smoking fire is typically much smaller than a grilling fire, the grilling grate 202 is located in a part of the chamber that has a larger volume to allow for a larger fire which is disposed in close proximity to the food being grilled on the cooking grate 118. Accordingly, the shape of the article body 102 and/or the article top 104 provides the ability for the smoking/grilling article 100 to be able to achieve a cooking temperature using a total wattage of about 1750 watts.

It should be appreciated that while the invention has been described with reference to an exemplary embodiment, it will be understood by those skilled in the art that various changes, omissions and/or additions may be made, and equivalents may be substituted for elements thereof without departing from the spirit and scope of the invention. Moreover, the embodiments or parts of the embodiments may be combined in whole or in part without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A smoking/grilling article, comprising:
a controller;
an article body defining a body top opening communicated with a body cavity, wherein the body cavity includes a food section, a grilling section and a smoking section;
a food grate disposed in the food section proximate the body top opening;
a grilling grate disposed below the food grate in the grilling section; and
a smoking grate disposed below the grilling grate in the smoking section, wherein each of the grilling grate and the smoking grate include one or more hollow grate tubes containing one or more heating elements therein, and wherein the controller is electrically communicated with the one or more heating elements to control the operation of the one or more heating elements.

2. The smoking/grilling article of claim 1, further comprising an article top associated with the article body to cover/uncover the body top opening.

3. The smoking/grilling article of claim 2, wherein the article top is rotatably associated with the article body to rotate between a first configuration and a second configuration, wherein when in the first configuration, the article top is disposed to cover the body top opening and when in the second configuration, the article top is disposed to uncover the body top opening.

4. The smoking/grilling article of claim 1, further defines a body bottom opening and includes an article bottom disposed to cover the body bottom opening.

5. The smoking/grilling article of claim 4, wherein the article bottom is removably associated with the article body to cover/uncover the body bottom opening.

6. The smoking/grilling article of claim 1, wherein the article body further defines a grilling section opening communicated with the grilling section, and a smoking section opening communicated with the smoking section.

7. The smoking/grilling article of claim 1, further including a grilling section door, where the grilling section door is movably connected to the article body to cover and/or uncover the grilling section opening.

8. The smoking/grilling article of claim 1, further including a smoking section door, where the smoking section door is movably connected to the article body to cover and/or uncover the smoking section opening.

9. The smoking/grilling article of claim 1, further including a support structure having a plurality of support legs, wherein the article body is associated with the support structure such that the article body hangs from the support structure.

10. The smoking/grilling article of claim 1, wherein the grilling grate and the smoking grate is constructed from a material which conducts heat.

11. The smoking/grilling article of claim 1, wherein the grilling grate and/or the smoking grate is constructed from at least one of an aluminum and/or a stainless steel material.

12. A smoking/grilling article, comprising:
a controller;
an article body defining a body top opening and a body bottom opening and having an article bottom, wherein the body top opening and the body bottom opening are communicated with a body cavity,
wherein the body cavity includes a food section, a grilling section and a smoking section;
a food grate disposed in the food section proximate the body top opening;
a grilling grate disposed below the food grate in the grilling section;
a smoking grate disposed below the grilling grate in the smoking section, wherein each of the grilling grate and the smoking grate include one or more hollow grate tubes containing one or more heating elements therein, and wherein the controller is electrically communicated with the one or more heating elements to control the operation of the one or more heating elements, and
wherein the article bottom is removably associated with the article body to cover/uncover the body bottom opening.

13. The smoking/grilling article of claim 12, further comprising an article top associated with the article body to cover/uncover the body top opening.

14. The smoking/grilling article of claim 13, wherein the article top is rotatably associated with the article body to rotate between a first configuration and a second configuration, wherein when in the first configuration, the article top is disposed to cover the body top opening and when in the second configuration, the article top is disposed to uncover the body top opening.

15. The smoking/grilling article of claim 12, wherein the article body further defines a grilling section opening communicated with the grilling section, and a smoking section opening communicated with the smoking section.

16. The smoking/grilling article of claim 12, further including a grilling section door, where the grilling section door is movably connected to the article body to cover and/or uncover the grilling section opening.

17. The smoking/grilling article of claim 12, further including a smoking section door, where the smoking section door is movably connected to the article body to cover and/or uncover the smoking section opening.

18. The smoking/grilling article of claim 12, further including a support structure having a plurality of support legs, wherein the article body is associated with the support structure such that the article body hangs from the support structure.

19. The smoking/grilling article of claim 12, wherein the grilling grate and the smoking grate is constructed from a material which conducts heat.

20. The smoking/grilling article of claim 12, wherein the grilling grate and/or the smoking grate is constructed from at least one of an aluminum and/or a stainless steel material.
